(19) United States
(12) Patent Application Publication
(10) Pub. No.: US 2025/0263280 A1
(43) Pub. Date: Aug. 21, 2025

(54) SCISSOR LIFT

(71) Applicant: Custom Equipment, LLC, Richfield, WI (US)

(72) Inventors: Brendan J. Foster, West Allis, WI (US); Sean M. McGlone, West Bend, WI (US); Mac S. Abfall, Kewaskum, WI (US)

(21) Appl. No.: 19/054,128

(22) Filed: Feb. 14, 2025

Related U.S. Application Data
(60) Provisional application No. 63/554,106, filed on Feb. 15, 2024.

(51) Int. Cl. B66F 11/04

(52) U.S. Cl. CPC B66F 11/042

(57) ABSTRACT

Lift equipment includes a chassis, a prime mover, multiple wheels, a lift platform, and a scissor stack assembly. The scissor stack assembly includes a first scissor cross, a second scissor cross, a third scissor cross, and an actuator. The first scissor cross is coupled to the chassis and has first links of a first link length. The second scissor cross is coupled to the lift platform and has second links of a second link length. The third scissor cross is coupled between the first scissor cross and the second scissor cross and has third links of a third link length. The actuator is coupled to the prime mover and is configured to transition the scissor stack assembly between a retracted position and an extended position. The first link length is different than at least one of: (i) the second link length or (ii) the third link length.

### CROSS REFERENCE TO RELATED APPLICATIONS

This application claims the benefit of and priority to U.S. Provisional Patent Application No. 63/554,106 filed on Feb. 15, 2024, the entirety of which is hereby incorporated by reference herein.

### BACKGROUND

The present disclosure relates generally to lift equipment and more particularly the present disclosure relates to scissor lifts and scissor stacks.

Lift equipment is often utilized to elevate a load (e.g., personnel, equipment, and/or materials) to an elevated work location. For example, lift equipment can be utilized to situate building materials on a ceiling or wall of a jobsite. Lift equipment may be transported to and from a jobsite, and often is maneuvered and operated within a jobsite.

### SUMMARY

At least one implementation relates to lift equipment including a chassis, a prime mover, multiple wheels, a lift platform, and a scissor stack assembly. The prime mover is coupled to the chassis. The multiple wheels are rotatably coupled to the chassis. The scissor stack assembly includes a first scissor cross, a second scissor cross, a third scissor cross, and an actuator. The first scissor cross is coupled to the chassis and has first links of a first link length. The second scissor cross is coupled to the lift platform and has second links of a second link length. The third scissor cross is coupled between the first scissor cross and the second scissor cross and has third links of a third link length. The actuator is operatively coupled to the prime mover and is configured to transition the scissor stack assembly between the retracted position and the extended position. The first link length is different than at least one of: (i) the second link length or (ii) the third link length.

At least one implementation relates to a scissor stack assembly for lift equipment. The scissor stack assembly includes a first scissor cross, a second scissor cross, a third scissor cross, and an actuator. The first scissor cross has a pair of first links configured to couple a base dock at a first end. The pair of first links has a first link length. The second scissor cross has a pair of second links configured to couple an platform dock at a second end. The pair of second links has a second link length. The third scissor cross has a pair of third links pivotally coupled between the first scissor cross and the second scissor cross. The pair of third links have a third link length and a link aperture. The actuator is disposed within the link aperture and is configured to selectively transition between a retracted position and an extended position to thereby influence an extension distance between the first end and the second end. The first link length is different than at least one of: (i) the second link length or (ii) the third link length.

At least one implementation relates to a scissor lift, including a chassis, multiple wheels, a lift platform, a first scissor cross, a second scissor cross, and a third scissor cross. The multiple wheels are rotatably coupled to the chassis. The first scissor cross is coupled to the chassis and has first links of a first link length. The second scissor cross is coupled to the lift platform and has second links of a second link length. The third scissor cross is coupled between the first scissor cross and the second scissor cross and has third links of a third link length. The first link length is different than at least one of: (i) the second link length or (ii) the third link length.

In some implementations, the first link length is less than the third link length. In some implementations, the second link length is less than the third link length. In some implementations, the third link length is less than the second link length. In some implementations, the first link length and the second link length are less than the third link length. In some implementations, the third link length is less than the first link length. In some implementations, the scissor stack assembly includes a fourth scissor cross having links of a fourth link length. In some implementations, the fourth scissor cross is coupled between the second scissor cross and the third scissor cross. In some implementations, the scissor stack assembly includes a fifth scissor cross having links of a fifth link length. In some implementations, the fifth scissor cross is coupled between the third scissor cross and the first scissor cross. In some implementations, the first link length and the second link length are less than the fourth link length and the fifth link length, and the fourth link length and the fifth link length are less than the third link length. In some implementations, the first links are arcuate or the second links are arcuate. In some implementations, the scissor stack defines an internal volume and the actuator is disposed within the internal volume. In some implementations, the scissor stack has an extension distance of at least 10 feet but not more than 30 feet. In some implementations, the extension distance is at least 10 feet. In some implementations, the collapsed distance of the scissor stack assembly is at most 18 inches.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a right perspective view of a scissor lift, according to an exemplary implementation;

FIG. 2 is a front right perspective view of the scissor lift of FIG. 1;

FIG. 3 is a front left perspective view of the scissor lift of FIG. 1;

FIG. 4 is a cross sectional view of the scissor lift of FIG. 1 taken along line A-A;

FIG. 5 is a right side view of a scissor stack, according to an exemplary implementation;

FIG. 6 is a top right rear perspective view of the scissor stack of FIG. 4;

FIG. 7 is a right side view of the scissor stack of FIG. 4;

FIG. 8 is a right side view of the scissor stack of FIG. 4;

FIG. 9 is a detail view of a scissor cross of the scissor stack of FIG. 4;

FIG. 10 is a plot of an actuation force, according to some implementations;

FIG. 11 is a plot of a maximum stress in a scissor stack, according to some implementations;

FIG. 12 is a plot of a minimum stress in a scissor stack, according to some implementations;

FIG. 13 is a linkage diagram of a scissor stack, according to some implementations; and

FIG. 14 is a schematic diagram of a side view of a scissor lift, according to some implementations.

### DETAILED DESCRIPTION

Before turning to the figures, which illustrate the exemplary implementations in detail, it should be understood that the present application is not limited to the details or methodology set forth in the description or illustrated in the figures. It should also be understood that the terminology is for the purpose of description only. Like reference numerals in the figures may represent and refer to the same or similar element, feature, or function.

Described in detail herein are systems and methods for improved lift equipment to better meet the needs of users. Lift equipment (e.g., areal lift equipment, low-access lift equipment, access lift equipment, etc.) is often utilized at a jobsite to provide access to one or more elevated portions of a jobsite. Operating lift equipment poses many technical challenges and can be difficult and burdensome. For example, uneven floors, low ceilings, constricted access points (e.g., doorways, elevator thresholds, etc.), and delicate floors (e.g., tiled floors, carpeted floors, marble floors, etc.) can burden or inhibit operation of lift equipment at a jobsite.

The lift equipment described herein provides solutions to these and other technical problems through a scissor stack assembly having scissor crosses of differing dimensions that facilitate improved mechanical performance, such as lower internal stresses, improved lift height, improved lift capacity, improved structural soundness, a compact footprint, and a low weight. The lift equipment described herein provides the user the flexibility to utilize lift equipment in environments that would otherwise be burdensome to lift equipment operations, and gives a user the flexibility to transport, store, and operate additional equipment in a space.

### Overall Machine

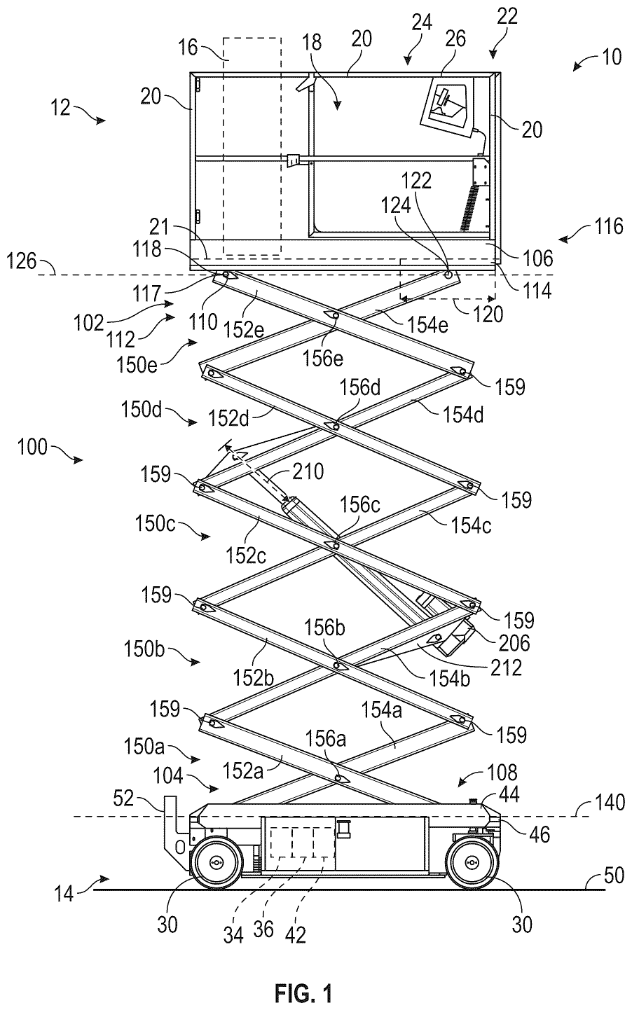

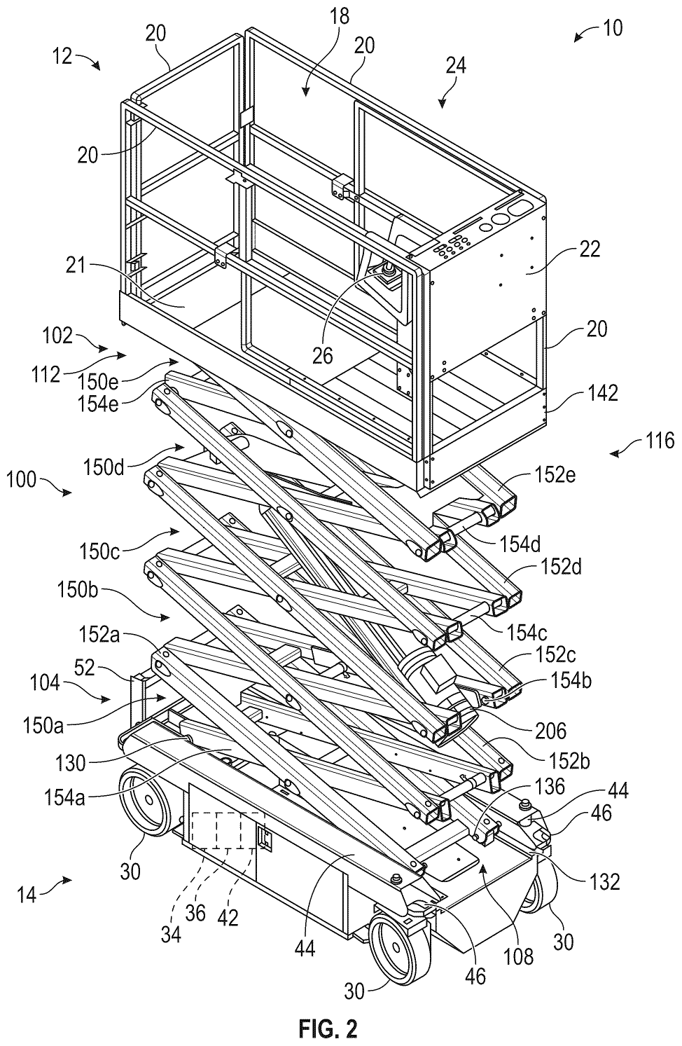

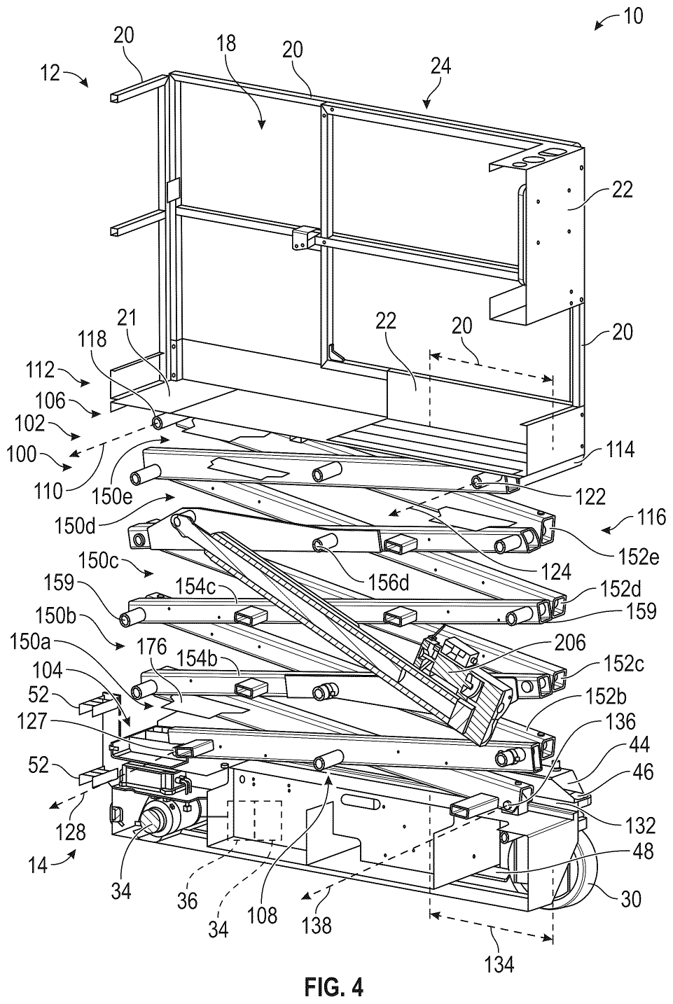

Referring now to FIGS. 1-4, lift equipment (e.g., areal lift equipment, low-access lift equipment, access lift equipment, etc.), shown as a scissor lift 10, includes a lift platform 12, a chassis 14, and a scissor stack assembly 100, according to some implementations. The lift platform 12 is configured to support and at least partially contain an operator 16 within a platform volume 18 defined within one or more rails 20 or walls and a platform floor 21, according to some implementations. The rails 20 may be configured to fold or detach to reduce the distance between the top of the rails 20 and the platform floor 21. The platform volume 18 may at least partially contain equipment (e.g., welding machines, tools, etc.), building materials (e.g., fasteners, sheet metal, drywall, piping, electrical conduit, etc.), and personnel (e.g., operator 16). In some implementations, the lift platform 12 is configured to accommodate more than one operator 16 (e.g., two operators, three operators, four operators, etc.) within the platform volume 18. In some implementations, the lift platform 12 includes a slideout portion 22 that is configured to nest within a slideout housing portion 24 of the lift platform 12 in a retracted position, and slidably extend outwardly and away from the slideout housing portion 24 of the lift platform 12 in an extended position. In this way, the slideout 22 can increase or decrease the size of the platform volume 18, according to some implementations. In some implementations, the slideout portion 22 is configured to travel approximately thirty inches between the extended position and the retracted position.

In some implementations, the lift platform 12 includes a user interface 26 configured to receive one or more user inputs regarding control of one or more operations of the scissor lift 10 (e.g., a direction of travel, an application of brakes, a platform height, etc.).

In some implementations, the chassis 14 is configured to support the scissor stack assembly 100 and the lift platform 12. The chassis 14 may include one or more wheels 30. In some implementations, one or more of the wheels 30 may be tractive wheels. In some implementations, one or more of the wheels 30 are caster wheels. In some implementations, the wheels 30 facilitate a zero-turn radius of the scissor lift 10. In some implementations, one or more wheels 30 are configured to steer the scissor lift 10 (e.g., spin, turn, pivot, etc.).

In some implementations, the chassis 14 includes a prime mover 34. In some implementations, the prime mover 34 is or includes an electric motor (e.g., an AC motor, a DC motor, etc.) and/or an internal combustion motor (e.g., diesel engine, petrol engine, natural gas engine, propane engine, etc.). In some implementations, the chassis 14 is self-propelled. For example, rotation of one or more wheels 30 may be driven by power from the prime mover 34. For example, one or more of the wheels 30 may be coupled to the prime mover 34 directly (e.g., hub motor) and/or via a drivetrain.

In some implementations, the chassis 14 includes an energy storage device 36 (e.g., fuel tank, battery, battery array, capacitor bank, etc.) configured to supply energy to the prime mover 34. In some implementations, the energy storage device 36 is or includes one or more lithium-ion batteries (e.g., a lithium cobalt oxide battery, a lithium iron phosphate battery, a lithium magnesium oxide battery, etc.) and/or a valve regulated lead-acid battery (e.g., a sealed lead-acid battery, an absorbent glass mat battery, etc.).

In some implementations, the chassis 14 includes a user interface 38. The user interface 38 is configured to receive one or more inputs via input device 40. For example, input device 40 may include one or more button, toggle switches, valve, touch sensitive surface, and/or joystick. In some implementations, the user interface 38 is configured to send messages to a controller 42 (e.g., microprocessor, a system on a chip, computing device, etc.) based on an input received by the input device 40. In some implementations, the controller 42 is configured to control one or more operations of the scissor lift 10. For example, the controller 42 may be configured to control one or more actuators (e.g., a hydraulic cylinder, an electric motor, a linear drive device, the actuator 206, etc.) and receive sensor values from one or more sensors (e.g., contact sensors, position sensors, proximity sensors, temperature sensors, speed sensors, timers, etc.).

In some implementations, the chassis 14 includes fork pockets 44 and anchors 46 that are configured to facilitate lifting (e.g., by crane, by hoist, etc.) or transporting the scissor lift 10. In some implementations, the chassis 14 includes deployable supports 48. The deployable supports 48 are configured to provide additional contact between the chassis 14 and the ground surface 50 when the scissor lift 10 is stationary (e.g., parked), according to some implementations. In some implementations, the chassis 14 includes a step 52 configured to aid in ergonomic access to the platform volume 18 of the lift platform 12.

### Scissor Stack Assembly

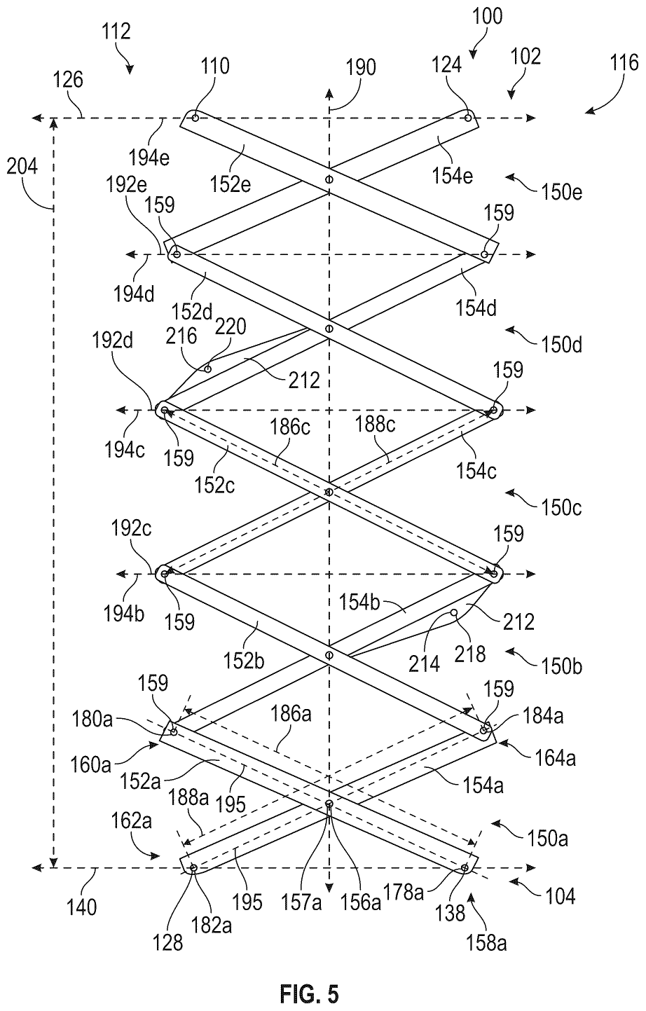

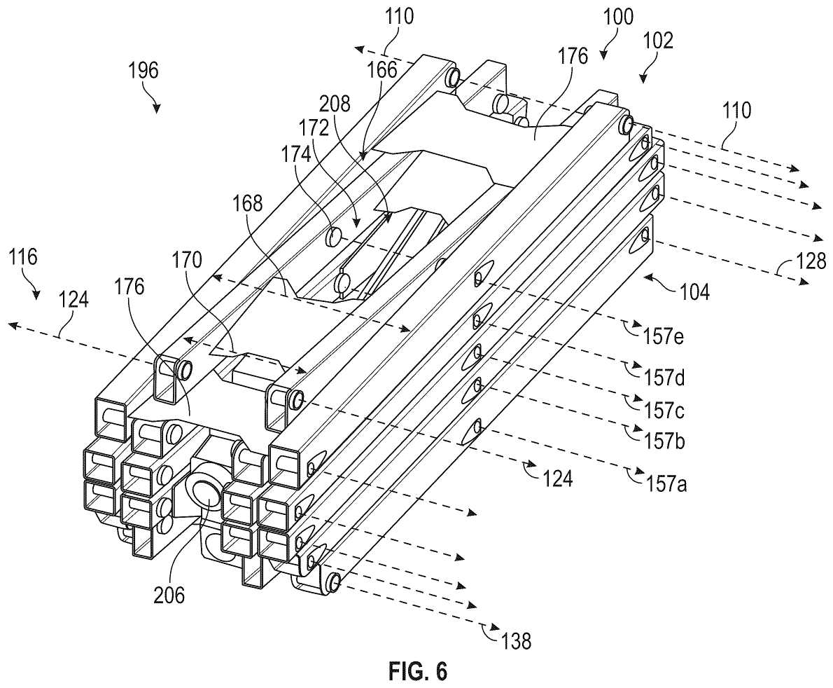

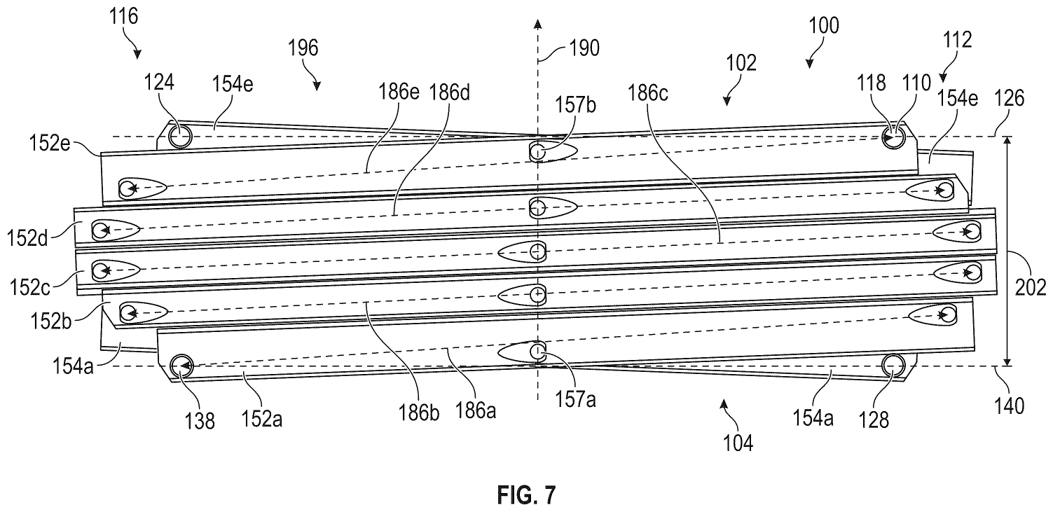

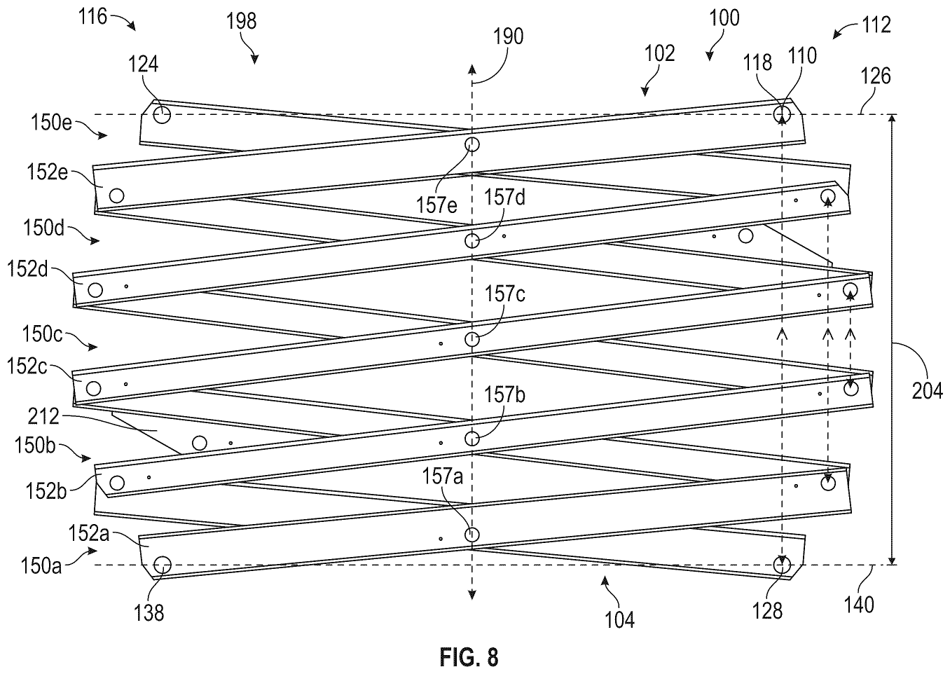

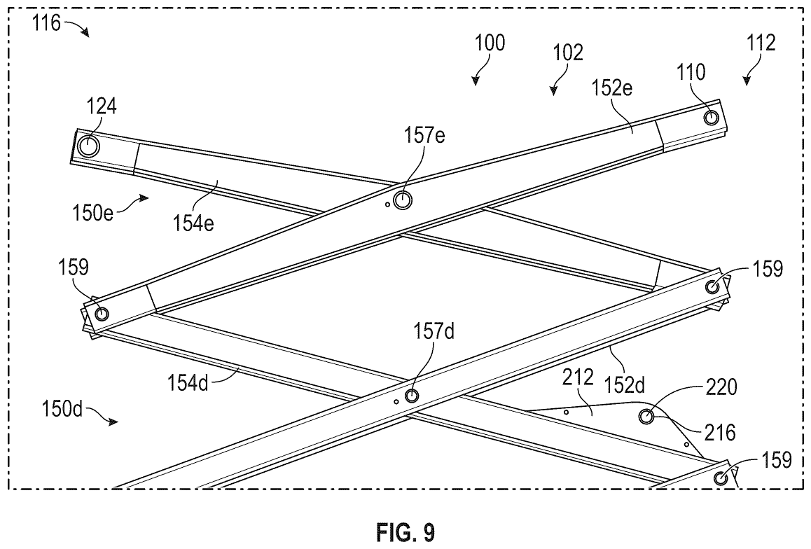

Referring to FIGS. 1-9, the scissor stack assembly 100 is coupled to the lift platform 12 at an implement end 102 and the chassis 14 at a base end 104. The scissor stack assembly 100 is configured to support the lift platform 12 and regulate the distance (e.g., height) between the lift platform 12 and the chassis 14.

In some implementations, the scissor stack assembly 100 includes a platform dock 106. The platform dock 106 may couple the lift platform 12 to the scissor stack assembly 100. The platform dock 106 includes a mount 117 (e.g., a dowel pin receptacle, a bearing, pin hole, a bushing, etc.) that extends along a platform pin axis 110 at a rear end 112. The platform pin axis 110 extends along the longitudinal axis (e.g., pivot axis) of a platform pin 118 (e.g., a dowel pin, etc.). In some implementations, the platform pin 118 is configured to engage the mount 117 and pivotally couple the platform dock 106 to the scissor stack assembly 100.

In some implementations, the platform dock 106 includes a platform pin slider track 114 at a front end 116. In some implementations, the front end 116 is the end that leads in the direction of travel of the chassis 14. The platform pin slider track 114 extends along an implement slider length 120 in a direction perpendicular to the platform pin axis 110, according to some implementations. The platform pin slider track 114 is configured to enforce substantially linear motion of an implement slider pin 122 along the implement slider length 120. The implement slider pin 122 extends along an implement slider pin axis 124. In some implementations, the implement slider pin axis 124 is parallel to the platform pin axis 110. In some implementations, the implement slider pin axis 124 and the implement slider length 120 define an implement slider plane 126. In some implementations, the platform pin axis 110 is in plane with the implement slider plane 126.

In some implementations, the scissor stack assembly 100 includes a base dock 108. In some implementations, the base dock 108 couples the chassis 14 to the scissor stack assembly 100. The base dock 108 includes a mount 127 (e.g., a dowel pin receptacle, a bearing, pin hole, a bushing, etc.) that extends along a base pin axis 128 at the rear end 112. The base pin axis 128 extends along the longitudinal axis (e.g., pivot axis) of a base pin 130. In some implementations the base pin 130 is configured to engage the mount 127 and pivotally couple the base dock 108 to the scissor stack assembly 100.

In some implementations, base dock 108 includes a base pin slider track 132 at the front end 116. The base pin slider track 132 extends along a base pin slider length 134 in a direction perpendicular to the base pin axis 128, according to some implementations. The base pin slider track 132 is configured to enforce substantially linear motion of a base slider pin 136 along the base pin slider length 134. The base slider pin 136 extends along a base slider pin axis 138. The base slider pin axis 138 is parallel to the base pin axis 128. In some implementations, the base pin axis 128 and the base pin slider length 134 define a base slider plane 140. In some implementations, the base pin axis 128 is in plane with the base slider plane 140. In some implementations, the base pin axis 128 and the platform pin axis 110 are parallel, and the base slider plane 140 and the implement slider plane 126 are parallel.

In some implementations, the platform dock 106 is configured to receive a portion of the lift platform 12 and releasably couple the lift platform 12 by one or more removable fasteners 142 (e.g., bolts, screws, pins, ball and detent, etc.). In some implementations, the lift platform 12 may be separated or dismounted from the platform dock 106 (e.g., by loosening or removing the removable fasteners 142) and then a different implement (e.g., a lift platform with shorter rails, a flat platform, a renewed lift platform 12, etc.) may be coupled to the platform dock 106. In some implementations, the platform dock 106 is built into the lift platform 12 (e.g., formed into, welded, etc.). In some implementations, the base dock 108 is built into the chassis 14.

Referring to FIGS. 1-9, the scissor stack assembly 100 includes multiple scissor crosses 150, according to some implementations. In some implementations, the scissor stack assembly 100 includes five scissor crosses 150. For ease of reference, each instance of a scissor cross 150 is assigned an alphabetic suffix (e.g., scissor cross 150a, scissor cross 150b, scissor cross 150c, scissor cross 150d, scissor cross 150e, etc.).

In some implementations, the scissor cross 150 includes a first link 152 and a second link 154. The first link 152 and the second link 154 are pivotally coupled (e.g., pinned) by a center pin 156. The center pin 156 extends along a center pin axis 157. The first link 152 has a proximal end 158 and a distal end 160. The link 154 has a proximal end 162 and a distal end 164. The proximal end 158 and the proximal end 162 are proximate to the base dock 108. The distal end 160 and the distal end 164 are distal to the base dock 108. In some implementations, the first link 152 defines a link aperture 166. In some implementations, a portion of the second link 154 passes through the link aperture 166. In some implementations, the second link 154 extends through the link aperture 166 and is pinned by the center pin 156 within the link aperture 166. In some implementations, the center pin 156 extends along the center pin axis 157 through a portion of the first link 152, then through a portion of the second link 154, and then through another portion of the first link 152. The first link 152 spans a link width 168 and the second link 154 spans a link width 170. In some implementations, the second link 154 defines a link aperture 172. In some implementations, the center pin 156 does not traverse the link aperture 172. For example, the center pin 156 may pass through a portion of the first link 152 and then a portion of the second link 154, and then a second center pin 174 may pass through a portion of the second link 154 and then a portion of the first link 152. The center pin 156 and the second center pin 174 extend along the center pin axis 157.

In some implementations, the scissor crosses 150 are linked by end pins 159. The end pins 159 pivotally couple the proximal end 162 and the proximal end 158 of a scissor cross 150 to the distal end 160 and distal end 164 of an adjacent scissor cross 150.

In some implementations, the first link 152 includes a link plate 176 at the distal end 160 and/or the proximal end 158. In some implementations, the first link 152 and the second link 154 include interlocking knuckles that are each configured to receive a pin and pivotally couple (e.g., hinge) the first link 152 and the second link 154 about the pin.

In some implementations, the first link 152 includes a mount (e.g., bearing, through hole, pin pocket, bushing, etc.) that extends along an end pin axis 178 at the distal end 160, and a mount that extends along an end pin axis 180 at the proximal end 158. The end pin axis 178 and the end pin axis 180 are parallel. The second link 154 includes an end pin axis 182 at the distal end 164 and an end pin axis 184 at the proximal end 162. The end pin axis 182 and the end pin axis 184 are parallel. In some implementations, the end pin axis 178, end pin axis 180, end pin axis 182, end pin axis 184, and center pin axis 157 are parallel. The end pins 159 extend along the end pin axes 178, 180, 182, 184.

In some implementations, the link 152 and/or the link 154 includes an elongated member (e.g., rectangular tube, pipe, rod, beam, etc.) that spans the length of the link. The link length 186 is the perpendicular distance between the end pin axis 178 and the end pin axis 180. The link length 188 is the perpendicular distance between the end pin axis 182 and the end pin axis 184. In some implementations, the link length 186 is at least 58 inches and not more than 66 inches. In some implementations, the link length 186 and the link length 188 are the same quantity. For example, the link length 186 and the link length 188 may both be thirty units of length (e.g., inches, centimeters, hands, etc.).

In some implementations, the end pin axis 178 and end pin axis 182 of a scissor cross are colinear with the end pin axis 184 and the end pin axis 180 of the adjacent scissor cross. For example, the scissor cross 150b is coupled to scissor cross 150c by end pins 159, and the end pin axis 178c is collinear with the end pin axis 184b, and the end pin axis 182c is collinear with the end pin axis 180b. The scissor cross 150a is coupled between the base dock 108 and the scissor cross 150b. The end pin axis 184a is colinear with the base pin axis 128, and the end pin axis 180a is colinear with the base slider pin axis 138. The proximal end 162a is pivotally coupled to the chassis 14 by the base pin 130 and the proximal end 162a is coupled to the base dock 108 by the base slider pin 136.

In some implementations, the scissor cross 150e is coupled between the platform dock 106 and the scissor cross 150d. In some implementations, the distal end 160e is pivotally coupled to the platform dock 106 by the platform pin 118. In some implementations, the distal end 164e is pivotally coupled to the platform dock 106 by the implement slider pin 122. In some implementations, the end pin axis 180e is colinear with the platform pin axis 110. In some implementations, the end pin axis 184e is colinear with the implement slider pin axis 124. In some implementations, the end pin axis 182e is colinear with the end pin axis 180d. In some implementations, the end pin axis 178e is colinear with the end pin axis 184d.

In some implementations, the center pins 156a, 156b, 156c, 156d, 156e are coplanar and define a center pin plane 190. The center pin plane 190 is perpendicular to the implement slider plane 126 and the base slider plane 140. The end pin axis 178 and the end pin axis 182 are coplanar and define a proximate end pin plane 192. The end pin axis 184 and the end pin axis 180 are coplanar and define a distal end pin plane 194. The proximate end pin plane 192 and the distal end pin plane 194 are parallel. The proximate end pin plane 192 and the distal end pin plane 194 are perpendicular to the center pin plane 190.

In some implementations, the scissor cross 150a and the scissor cross 150e have the same link length (e.g., 58 inches), and one or more of the interstitial scissor crosses (e.g., scissor cross 150b, scissor cross 150c, and/or scissor cross 150d) have a second length that is different than the first length (e.g., 64 inches). In some implementations, the link lengths 186a, 188a are less than the link lengths 186b, 188b. In some implementations, the link lengths 186a, 188a are greater than the link lengths 186b, 188b. In some implementations, the link lengths 186a, 188a are different than at least one of: (i) the link lengths 186c, 188c or (ii) the link lengths 186e, 188e. In some implementations, one or more of the link length 186a, the link length 186b, the link length 186c, the link length 186d, the link length 186e are different lengths. In some implementations, the link length 186a is less than the link length 186c. In some implementations, the link lengths 186e, 188e are less than the link lengths 186c, 188c. In some implementations, the link lengths 186c, 188c are less than the link lengths 186e, 188e. In some implementations, the link lengths 186a, 188a and the link lengths 186e, 188e are less than the link lengths 186c, 188c. In some implementations, the link lengths 186c, 188c are less than the link lengths 186a, 188a.

In some implementations, one or more of the links 152, 154 of the scissor stack assembly 100 are arcuate links, according to some implementations. For example, the center pin axis 157a may be offset from a link length plane 195a that contains the end pin axis 178a and the end pin axis 180a of the link 152a. In some implementations, the link 152a, the link 154a, the link 152e, and the link 154e are arcuate links. In some implementations, the link 152a and the link 154a are arced away from the base dock 108, and the link 152e and the link 154e are arced toward the base dock 108. For example, the center point of an arc perpendicular and tangent to the end pin axis 178a, the center pin axis 157a, and the end pin axis 180a is located to the side of the link length plane 195a that faces toward the base dock 108, according to some implementations. In some implementations, one or more scissor crosses 150 have arcuate links. In some implementations, the links 152a and the link 154a arc away from the base dock 108. In some implementations, the links 152e and the link 154e arc away from the base dock 108.

In some implementations, the scissor cross 150d is coupled between the scissor cross 150e and the scissor cross 150c. In some implementations, the scissor cross 150b is coupled between the scissor cross 150c and the scissor cross 150a. In some implementations, the link lengths 186a, 188a and the link lengths 186e, 188e are less than the link lengths 186d, 188d and the link lengths 186b, 188b; and the link lengths 186d, 188d and the link lengths 186b, 188b are less than the link lengths 186c, 188c. Advantageously, shorter link lengths 186, 188 at the base end 104 and/or implement end 102 can facilitate a smaller base dock 108 (and thereby a smaller chassis 14) and/or a smaller platform dock 106, which can reduce the overall footprint and weight of the scissor lift 10, according to some implementations.

In some implementations, the link length 174a, 176a, and the link length 174e, 176e are approximately 91% of the link length of an interstitial scissor cross (e.g., the link lengths 174b, 176b of scissor cross 150b, the link lengths 174b, 176b, the link lengths 174c, 176c of scissor cross 150c, the link lengths 174d, 176d of scissor cross 150d). In some implementations, the link length 174a, 176a, and the link length 174e, 176e are at most 91% of the link length of an interstitial scissor cross (e.g., the link lengths 174b, 176b of scissor cross 150b, the link lengths 174b, 176b, the link lengths 174c, 176c of scissor cross 150c, the link lengths 174d, 176d of scissor cross 150d). In some implementations, the link length 174b, 176b, and the link length 174d, 176d are approximately 97% of the link length of the link lengths 174c, 176c of scissor cross 150c. Unexpectedly, varied link lengths 186, 188 of scissor crosses 150 in the scissor stack assembly 100 reduces peak stresses and actuator loads in the scissor stack assembly 100.

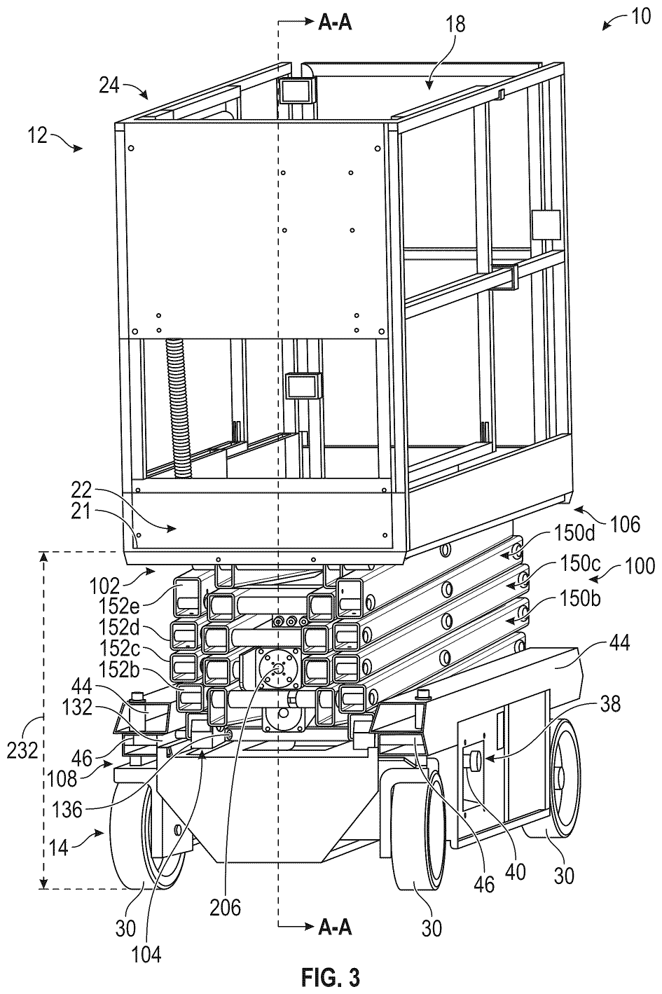

Referring to FIGS. 1-7, in operation, the scissor stack assembly 100 is configured to transition between a retracted position 196 (i.e., a stowed position, a collapsed position, a folded position) (see, e.g. FIGS. 3, 6, 7), and an extended position 198 (see, e.g., FIGS. 1, 2, 4, 5, 8). In the retracted position 196 the platform dock 106 is spaced from the base dock 108 by a collapsed distance 202 (e.g., collapsed height). In the extended position 198 the platform dock 106 is spaced from the base dock 108 by an extension distance 204. The collapsed distance 202 is the distance between the base slider plane 140 and the implement slider plane 126 when the scissor stack assembly 100 is in the retracted position 196. The extension distance 204 is the distance between the base slider plane 140 and the implement slider plane 126 when the scissor stack assembly 100 is in the extended position 196. The extension distance 204 is greater than the collapsed distance 202.

In some implementations, the scissor stack assembly 100 includes an actuator 206. In some implementations, the actuator 206 is a linear actuator (e.g., a hydraulic cylinder, a pneumatic cylinder, an electromechanical linear actuator, etc.). In some implementations, the actuator 206 is coupled between a pair of parallel or substantially parallel links of the scissor stack assembly 100. For example, the actuator 206 may be coupled between the link 154a and the link 154c. In some implementations, the actuator 206 is coupled between links of the same link length. In some implementations, the actuator 206 is coupled to a first scissor cross at a first end and is coupled to a second scissor cross at a second end. In some implementations, the scissor stack assembly 100 defines an internal volume 208 between the platform dock 106, the base dock 108, and the link aperture 172. In some implementations, the actuator 206 is contained within the internal volume 208.

In some implementations, in operation, the actuator 206 is configured to extend and retract along a stroke length 210, which influences the scissor crosses 150 to open or close, and thereby influences the scissor stack assembly 100 to extend or retract, according to some implementations. For example, when the actuator 206 extends, the distance between the end pin axis 178 and the end pin axis 182 decreases, and simultaneously the distance between: (i) the end pin axis 178 and the end pin axis 184; and (ii) the end pin axis 182 and the end pin axis 180; increases, and thus the extension distance 204 increases, according to some implementations. In some implementations, the scissor stack assembly 100 extends or retracts based on actuation of the actuator 206 over the stroke length 210.

In some implementations, the actuator 206 is coupled to actuator mounting plates 212. The actuator mounting plates 212 may be coupled to the scissor stack assembly 100 via one or more fasteners, welds, adhesives, or combinations thereof. In some implementations, the actuator mounting plates 212 are formed with one or more links 152, 154 (e.g., cast, additively manufactured, milled, etc.) and/or define a unitary body with the links 152, 154. The actuator 206 may be pivotally coupled to the actuator mounting plates 212 by actuator pin 214 and actuator pin 216. The actuator pin 214 extends along an actuator pin axis 218. The actuator pin 216 extends along an actuator pin axis 220. The actuator pin axis 218 and the actuator pin axis 220 are parallel. In some implementations, actuator pin axis 218 and the actuator pin axis 220 are spaced by approximately 48 inches when the scissor stack assembly 100 is in the retracted position 196. In some implementations, the actuator pin axis 218 and the actuator pin axis 220 are spaced by approximately 84 inches when the scissor stack assembly 100 is in the extended position 198. In some implementations, the actuator pin axis 218, the actuator pin axis 220, the center pin axes 157, the end pin axes 178, 180, 182, 184, the base pin axis 128, the platform pin axis 110, the base slider pin axis 138, and the implement slider pin axis 124 are parallel.

In some implementations, the scissor stack assembly 100 has a collapsed distance 202 that is at least 16 inches and not more than 18 inches. In some implementations, the scissor stack assembly 100 has an extension distance of approximately 25 feet. In some implementations, the scissor stack assembly 100 has an extension distance of at least 10 feet and not more than 40 feet. In some implementations, the scissor stack assembly 100 has a maximum footprint of approximately 70 inches by approximately 20 inches.

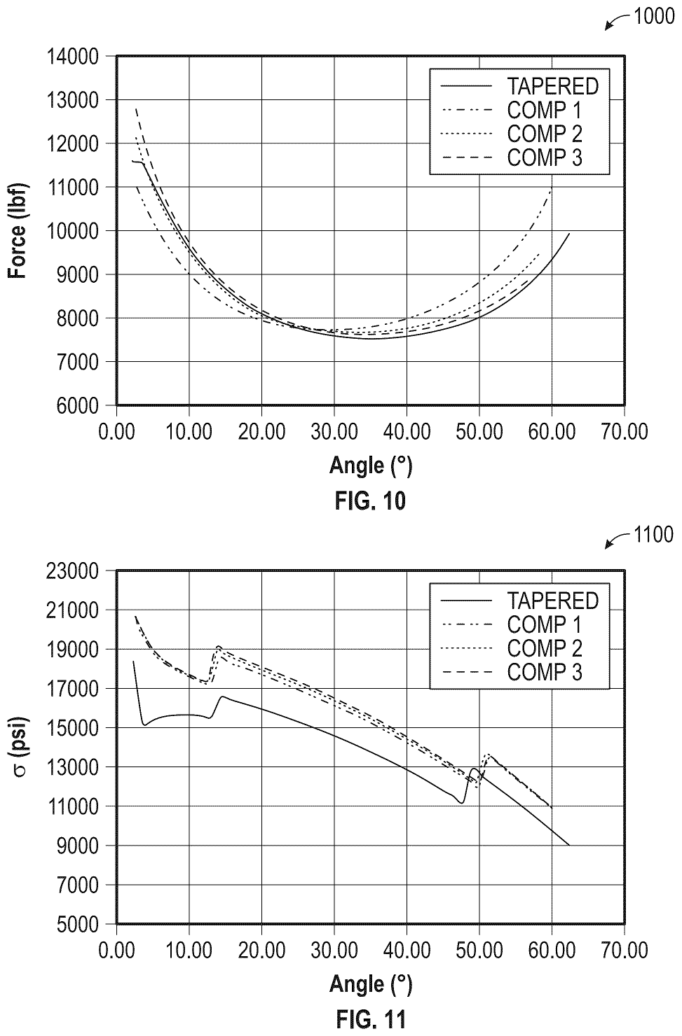

Referring to FIGS. 10-12, the actuation force and peak stresses of the scissor stack assembly 100 are shown, according to some implementations. The TAPERED plot line corresponds to a dataset of the scissor stack assembly 100, according to some implementations. For the datasets shown in FIGS. 10-12: the link lengths 186a, 188a, and the link lengths 186e, 188e are 58 inches; the link lengths 186b, 188b, and the link lengths 186d, 188d are 64 inches; the link lengths 186c, 188c are 66 inches; the links 152a, 154a are arcuate and arc away from the base end 104; the center pin axis 157a is offset from the link length plane 195a by 1.55 inches; the links 152e, 154e are arcuate and arc toward the base end 104; and the center pin axis 157e is offset from the link length plane 195e by 1.55 inches. The COMP 1 plot line corresponds to a dataset of a scissor stack where all links are linear, and all link lengths are 64.6 inches. The COMP 2 plot line corresponds to a dataset of a scissor stack where all links are linear, and all link lengths are 65.8 inches. The COMP 3 plot line corresponds to a dataset of a conventional scissor stack where all links are linear, and all link lengths are 66.4 inches. The left-hand ends of the plot lines correspond to the retracted position 196. The right-hand ends of the plot lines correspond to the extended position 198. For each of the plot lines, the right-most end of the plot line corresponds to an equivalent extension distance 204. For example, each stack was tested over the same vertical distance using the same actuator.

FIG. 10 is an illustration of a plot 1000 of the force supplied by the actuator while the scissor stack travels from the retracted position 196 to the extended position 198, according to some implementations.

FIG. 11 is an illustration of a plot 1100 of the maximum stress experienced by at least one link of the scissor stack assembly 100 while the scissor stack travels from the retracted position 196 to the extended position 198, according to some implementations. The maximum stress accounts for axial stresses, bending stresses, shear stresses, and torsional stresses.

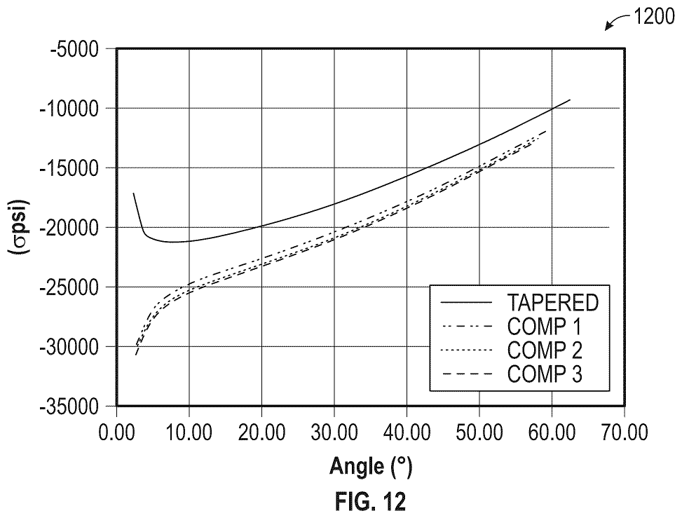

FIG. 12 is an illustration of a plot 1200 of the minimum stress experienced by a link of the scissor stack assembly 100 while the scissor stack travels from the retracted position 196 to the extended position 198, according to some implementations. The minimum stress accounts for axial stresses, bending stresses, shear stresses, and torsional stresses.

Unexpectedly, the scissor stack assembly 100 experiences a lower maximum stress (e.g., 42.6% less than COMP 1, 43.7% less than COMP 2, 44.3% less than COMP 3) and a lower average actuator force (e.g., 1.7% less than COMP 1, 0.5% less than COMP 2, 0.4% less than COMP 3), among other technical benefits.

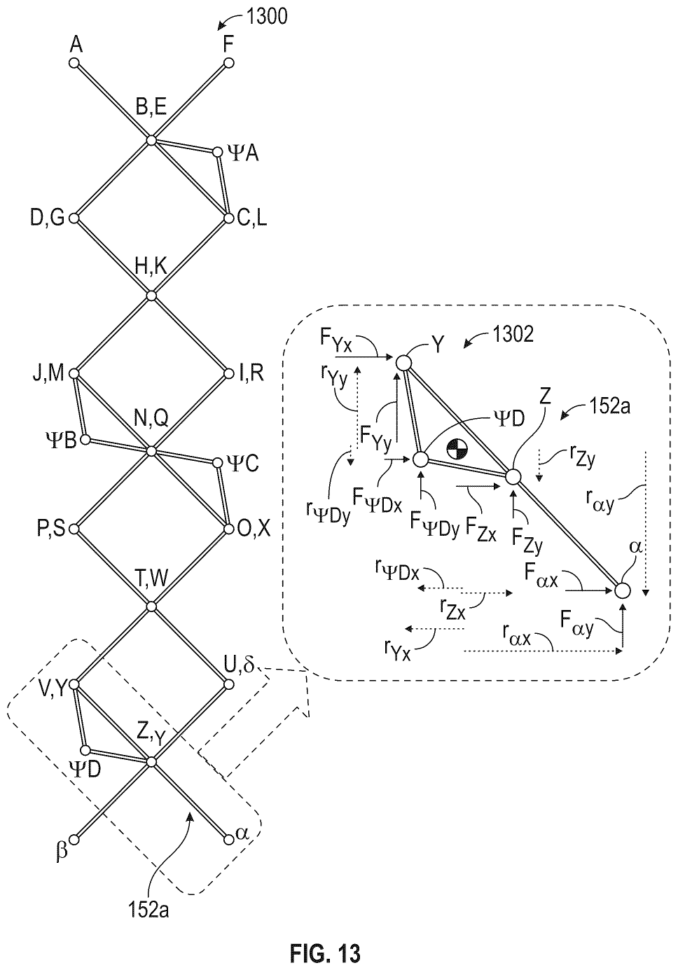

FIG. 13 is an illustration of a linkage diagram 1300 of the scissor stack assembly 100, including a free body diagram 1302 of link 152a, according to some implementations. In the free body diagram 1302, each “F” represents a force, and each “r” is a moment arm relative to the center of mass, according to some implementations. In FIG. 13, the arrows shown with arrow heads in the general vicinity of a point correspond to a force applied to the point. For example, in free body diagram 1302, point a of the member YZα is the point at which the forces r_{ay}, Fₐₓ, F_{ay}, and rₐₓ are applied to the member YZα. As another example, in free body diagram 1302, point Z of the member YZα is the point at which the forces r_{zy}, F_{Zx}, F_{Zy}, and r_{Zx} are applied to the member YZα. In linkage diagram 1300 and free body diagram 1302, pin point ΨA and pin point ΨB are a pair associated with mounting points of a first actuator (e.g., actuator 206), and pin point ΨC and pin point ΨD are a pair associated with mounting points of a second actuator.

Referring again to FIG. 3, the access height 232 of the scissor lift 10 is the distance between the platform floor 21 and the ground surface 50. In some implementations, the access height 232 is at most 34 inches. In some implementations, the base slider plane 140 is at least 26 inches and not more than 34 inches above the ground surface 50. In some implementations, the rails 20 are approximately 78 inches above the ground surface 50 when the scissor stack assembly 100 is in the retracted position 196. In some implementations, the rails 20 are not higher than 78 inches above the ground surface 50 when the scissor stack assembly 100 is in the extended position 198. In some implementations, the footprint of the scissor lift 10 is at least 30 inches by 64 inches but not more than 32 inches by 80 inches.

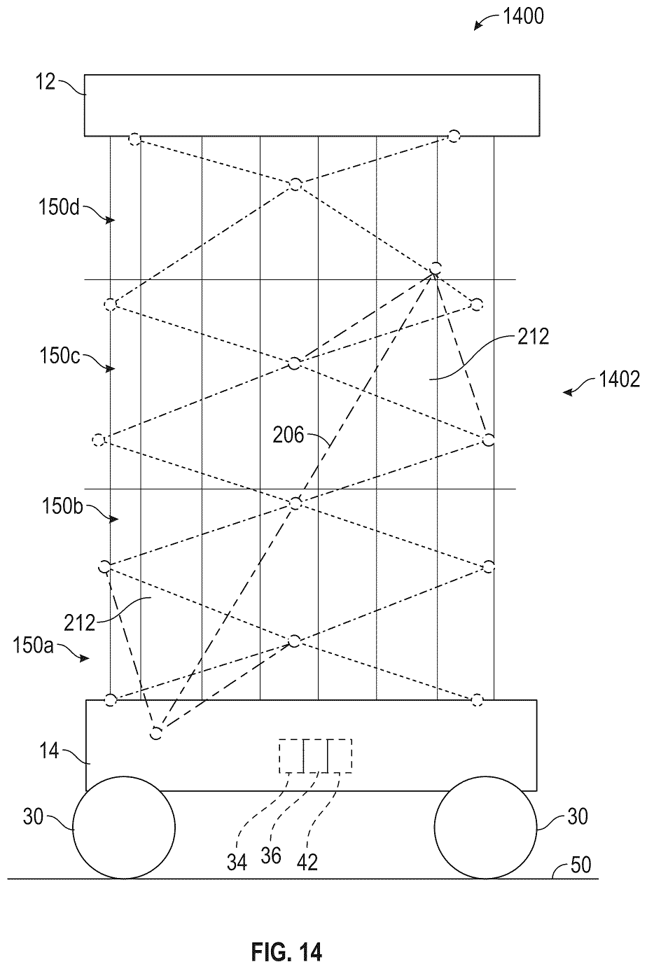

Referring to FIG. 14, a scissor lift 1400 includes the chassis 14, the lift platform 12, and a scissor stack 1402, according to some implementations. The scissor stack 1402 includes four scissor crosses 150. The scissor cross 150a is coupled to the chassis 14 and the scissor cross 150b. The scissor cross 150b is coupled to the scissor cross 150a and the scissor cross 150c. The scissor cross 150c is coupled to the scissor cross 150b and the scissor cross 150d. The scissor cross 150d is coupled to the lift platform 12 and the scissor cross 150c.

Although the scissor stack assembly 100 is illustrated as having five scissor crosses 150 and the scissor stack 1402 is illustrated as having four scissor crosses 150, in some implementations the scissor stack assembly 100 has more or fewer scissor crosses 150 (e.g., two scissor crosses, three scissor crosses, six scissor crosses, seven scissor crosses, eight scissor crosses, nine scissor crosses, etc.). In such implementations, the terminal scissor cross of the scissor stack (i.e., the scissor cross furthest from the base dock 108) is coupled to the platform dock 106.

In some implementations, the scissor stack assembly 100 includes multiple actuators 206 (e.g., two actuators, three actuators, etc.). In such implementations, the actuators 206 may work in tandem or in a sequence at the same or different locations of the scissor stack assembly 100. For example, a first actuator 206 may be coupled between the link 154a and the link 154c, and a second actuator 206 may be coupled between the link 154c and the link 154e. In some implementations, an actuator 206 is configured to extend in the direction of the implement slider length 120. For example, an actuator 206 may be directly coupled to the implement slider pin 122 and be configured to slide the implement slider pin 122 in the implement slider plane 126. In some implementations, an actuator 206 is configured to extend in the direction of the base pin slider length 134. For example, an actuator 206 may be coupled to the base slider pin 136 and be configured to slide the base slider pin 136 in the base pin slider plane 140.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as utilized herein to describe various implementations, are intended to indicate that such implementations are possible examples, representations, or illustrations of possible implementations (and such terms are not intended to connote that such implementations are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary implementations, and that such variations are intended to be encompassed by the present disclosure.

It is important to note that the construction and arrangement of the scissor lift 10 as shown in the various exemplary implementations is illustrative only. Additionally, any element disclosed in one implementation may be incorporated or utilized with any other implementation disclosed herein. Although only one example of an element from one implementation that can be incorporated or utilized in another implementation has been described above, it should be appreciated that other elements of the various implementations may be incorporated or utilized with any of the other implementations disclosed herein.

What is claimed is:

1. Lift equipment, comprising:
a chassis;
a prime mover coupled to the chassis;
a plurality of wheels rotatably coupled to the chassis;
a lift platform; and
a scissor stack assembly configured to transition between a retracted position and an extended position, the scissor stack assembly comprising:
a first scissor cross coupled to the chassis and having first links of a first link length;
a second scissor cross coupled to the lift platform and having second links of a second link length;
a third scissor cross coupled between the first scissor cross and the second scissor cross and having third links of a third link length; and
an actuator operatively coupled to the prime mover and configured to transition the scissor stack assembly between the retracted position and the extended position;
wherein the first link length is different than at least one of: (i) the second link length or (ii) the third link length.

2. The lift equipment of claim 1, wherein the first link length is less than the third link length.

3. The lift equipment of claim 1, wherein the second link length is less than the third link length.

4. The lift equipment of claim 1, wherein the third link length is less than the second link length.

5. The lift equipment of claim 1, wherein the first link length and the second link length are less than the third link length.

6. The lift equipment of claim 1, wherein the third link length is less than the first link length.

7. The lift equipment of claim 1, wherein the scissor stack assembly further comprises:
a fourth scissor cross having links of a fourth link length;
wherein the fourth scissor cross is coupled between the second scissor cross and the third scissor cross.

8. The lift equipment of claim 7, wherein the scissor stack assembly further comprises:
a fifth scissor cross having links of a fifth link length;
wherein the fifth scissor cross is coupled between the third scissor cross and the first scissor cross.

9. The lift equipment of claim 8, wherein the first link length and the second link length are less than the fourth link length and the fifth link length, and wherein the fourth link length and the fifth link length are less than the third link length.

10. The lift equipment of claim 1, wherein the first links are arcuate or the second links are arcuate.

11. The lift equipment of claim 1, wherein the scissor stack assembly defines an internal volume and wherein the actuator is disposed within the internal volume.

12. The lift equipment of claim 1, wherein the scissor stack assembly has an extension distance of at least 10 feet.

13. The lift equipment of claim 1, wherein the scissor stack assembly has a collapsed distance of at most 18 inches.

14. A scissor stack assembly for lift equipment, comprising:
a first scissor cross having a pair of first links configured to couple a base dock at a first end, wherein the first links having a first link length;
a second scissor cross having a pair of second links configured to couple an platform dock at a second end, wherein the second links have a second link length;
a third scissor cross having a pair of third links pivotally coupled between the first scissor cross and the second scissor cross, wherein the third links have a third link length and a link aperture; and
an actuator disposed within the link aperture and configured to selectively transition between a retracted position and an extended position to thereby influence an extension distance between the first end and the second end;
wherein the first link length is different than at least one of: (i) the second link length or (ii) the third link length.

15. The scissor stack assembly of claim 14, wherein the first link length and the second link length are less than the third link length.

16. The scissor stack assembly of claim 14, further comprising:
a fourth scissor cross having a pair of fourth links having a fourth link length; and
a fifth scissor cross having a pair of fifth links having a fifth link length;
wherein the fourth scissor cross is coupled between the second scissor cross and the third scissor cross, and the fifth scissor cross is coupled between the third scissor cross and the first scissor cross; and
wherein the first link length is less than the fifth link length, and the fifth link length is less than the third link length.

17. The scissor stack assembly of claim 14, wherein the pair of first links are arcuate and the pair of second links are arcuate.

18. The scissor stack assembly of claim 14, wherein the extension distance is 10 feet to 30 feet.

19. A scissor lift, comprising:
a chassis;
a plurality of wheels rotatably coupled to the chassis;
a lift platform;
a first scissor cross coupled to the chassis and having first links of a first link length;
a second scissor cross coupled to the lift platform and having second links of a second link length; and
a third scissor cross coupled between the first scissor cross and the second scissor cross and having third links of a third link length;
wherein the first link length is different than at least one of: (i) the second link length or (ii) the third link length.

20. The scissor lift of claim 19, wherein the first link length and the second link length are less than the third link length.
